(19) United States
(12) Patent Application Publication
(10) Pub. No.: US 2025/0247009 A1
(43) Pub. Date: Jul. 31, 2025

(54) CONVERSION CONTROL CIRCUIT AND CONVERSION CONTROL METHOD CAPABLE OF RECYCLING ENERGY

(71) Applicant: Richtek Technology Corporation, Hsinchu (TW)

(72) Inventors: Tzu-Chen Lin, Hsinchu (TW); Yi-Min Shiu, Hsinchu (TW); Chao-Chi Chen, New Taipei (TW)

(21) Appl. No.: 18/795,218

(22) Filed: Aug. 6, 2024

Related U.S. Application Data
(60) Provisional application No. 63/626,533, filed on Jan. 30, 2024.

(30) Foreign Application Priority Data
Jun. 11, 2024 (TW) 113121541

(51) Int. Cl. H02M 3/335

(52) U.S. Cl. CPC H02M 3/33592; H02M 3/33571; H02M 3/33584

(57) ABSTRACT

A conversion control circuit capable of recycling energy is configured to control an isolated power converter, converting an input power to generate an output power. The conversion control circuit generates an optocoupler current for a photodiode included in the optocoupler based on a control-related signal, transmitting the information of the control-related signal between the primary and secondary sides of the power converter via optical coupling to achieve power conversion. The conversion control circuit comprises a controllable current source circuit and a power conversion circuit. The controllable current source circuit generates a controllable current based on the control-related signal, wherein at least a portion of the controllable current is coupled to provide the optocoupler current. The power conversion circuit converts at least a portion of the optocoupler current into a supply power for an operating circuit, thereby recycling the energy generated by the optocoupler current.

### CROSS REFERENCE

The present invention claims priority to U.S. 63/626,533 filed on Jan. 30, 2024. The present invention claims priority to TW patent application Ser. No. 11/312,1541, filed on Jun. 11, 2024.

### BACKGROUND OF THE INVENTION

### Field of Invention

The present invention relates to a conversion control circuit and a conversion control method capable of recycling energy, specifically referring to a conversion control circuit and method that can recycle the energy generated by the optocoupler current used to drive an optocoupler through a first power conversion circuit and/or a second power conversion circuit.

### Description of Related Art

Conventional isolated conversion control circuits provide an optocoupler current to transmit information between the primary and secondary sides through the optocoupler to achieve power conversion. The optocoupler current causes a certain proportion of power loss under extremely light load conditions.

In view of the above, the present invention addresses the shortcomings of the prior art by proposing a conversion control circuit and method that recycle the energy generated by the optocoupler current related to the output power through the first power conversion circuit and/or the second power conversion circuit, thereby improving the power conversion efficiency of the isolated power converter.

### SUMMARY OF THE INVENTION

In one perspective, the present invention provides a conversion control circuit capable of recycling energy for controlling an isolated power converter that converts an input power to generate an output power. The isolated power converter includes a primary side coupled to the input power and a secondary side coupled to the output power. The conversion control circuit generates an optocoupler current for a photodiode included in the optocoupler based on a control-related signal, thereby transmitting information related to the control-related signal between the primary and secondary sides via optical coupling to achieve power conversion. The conversion control circuit comprises: a controllable current source circuit for generating a controllable current based on the control-related signal, wherein at least a portion of the controllable current provides the optocoupler current; and a first power conversion circuit that converts at least a portion of the optocoupler current into a supply power to power an operating circuit, thereby recycling the energy generated by the optocoupler current.

In one embodiment, the conversion control circuit capable of recycling energy further includes a second power conversion circuit to provide a regulated power, wherein the regulated power and the supply power are connected in parallel to power the operating circuit.

In one embodiment, the operating circuit consumes an operating current for operation, wherein a regulation current of the regulated power is related to a difference between at least a portion of the optocoupler current and the operating current, or the regulation current is related to a difference between a supply current of the supply power and the operating current.

In one embodiment, the first power conversion circuit is a linear regulator or a switching power converter.

In one embodiment, the second power conversion circuit is a linear regulator or a switching power converter.

In one embodiment, the control-related signal is related to an electrical characteristic of the output power, and the conversion control circuit regulates the electrical characteristic to a predetermined target level based on the control-related signal.

In one embodiment, the controllable current source circuit includes a transconductance amplifier to convert the difference between the electrical characteristic and the reference signal into the controllable current.

In one embodiment, the electrical characteristic is an output voltage or an output current of the output power.

In one embodiment, the controllable current source circuit and the first power conversion circuit are coupled in parallel and then are coupled to the photodiode; or the controllable current source circuit, the first power conversion circuit, and the photodiode are coupled in series.

In one embodiment, the regulation current is bidirectional.

In one embodiment, the isolated power converter is a flyback power converter, which includes a power transformer coupled between the input power and the output power; a half-bridge circuit consisting of a primary-side high-side switch and a primary-side low-side switch to switch a primary winding of the power transformer and a resonant capacitor forming a resonant circuit; and a synchronous rectifying (SR) switch coupled in series with a secondary winding of the power transformer between the output power and a secondary ground node. The primary-side high-side switch and the primary-side low-side switch are controlled by a primary-side control circuit coupled to a phototransistor included in the optocoupler to generate a switching signal, which controls the primary-side high-side switch and the primary-side low-side switch to switch the primary winding of the power transformer. The SR switch is controlled by a secondary-side control circuit, which generates the optocoupler current to drive the photodiode and produces an SR control signal to control the on-off state of the SR switch, thereby switching the secondary winding of the power transformer to generate the output voltage. The conversion control circuit includes the secondary-side control circuit.

In one embodiment, the second power conversion circuit converts the output voltage or a cross-voltage of an auxiliary winding included in the power transformer to generate the regulation current.

In another perspective, the present invention provides a conversion control method capable of recycling energy to control an isolated power converter that converts an input power to generate an output power. The isolated power converter includes a primary side coupled to the input power and a secondary side coupled to the output power. The conversion control method generates an optocoupler current for a photodiode included in the optocoupler based on a control-related signal, thereby transmitting information related to the control-related signal between the primary and secondary sides via optical coupling to achieve power conversion. The conversion control method comprises: generating a controllable current based on the control-related signal, wherein at least a portion of the controllable current provides the optocoupler current; and converting at least a portion of the optocoupler current into a supply power to power an operating circuit, thereby recycling the energy generated by the optocoupler current.

In one embodiment, the conversion control method capable of recycling energy further includes providing a regulated power, wherein the regulated power and the supply power are connected in parallel to power the operating circuit.

In one embodiment, the conversion control method capable of recycling energy further includes converting the difference between the electrical characteristic and the reference signal into the controllable current.

In one embodiment, the regulation current is bidirectional.

In one embodiment, the conversion control method capable of recycling energy further includes converting the output voltage or a cross-voltage of an auxiliary winding to generate the regulation current.

The objectives, technical details, features, and effects of the present invention will be better understood with regard to the detailed description of the embodiments below, with reference to the attached drawings.

### BRIEF DESCRIPTION OF THE DRAWINGS

FIG. 1A shows a circuit block diagram of a conversion control circuit capable of recycling energy according to one embodiment of the present invention.

FIG. 1B shows a circuit block diagram of a conversion control circuit capable of recycling energy according to another embodiment of the present invention.

FIG. 2 shows a circuit block diagram of a conversion control circuit capable of recycling energy according to one embodiment of the present invention, wherein the control-related signal is related to the difference between the electrical characteristics of the output power and the reference signal.

FIG. 3A shows a circuit block diagram of a conversion control circuit capable of recycling energy according to one embodiment of the present invention, wherein the controllable current source circuit, the first power converter, and the photodiode are coupled in series.

FIG. 3B shows a circuit block diagram of a conversion control circuit capable of recycling energy according to another embodiment of the present invention, wherein the controllable current source circuit and the first power converter are coupled in parallel to the photodiode.

FIG. 4A shows a circuit block diagram of a conversion control circuit capable of recycling energy according to one embodiment of the present invention, wherein the conversion control circuit further includes a second power conversion circuit in parallel with the first power converter, and the controllable current source circuit, the first power converter, and the photodiode are coupled in series.

FIG. 4B shows a circuit block diagram of a conversion control circuit capable of recycling energy according to another embodiment of the present invention, wherein the conversion control circuit further includes a second power conversion circuit in parallel with the first power converter, and the controllable current source circuit and the first power converter are coupled in parallel to the photodiode.

FIG. 5 shows a block diagram of a linear regulator as the first power conversion circuit in a conversion control circuit capable of recycling energy according to one embodiment of the present invention.

FIG. 6 shows a block diagram of a linear regulator as the second power conversion circuit in a conversion control circuit capable of recycling energy according to one embodiment of the present invention.

FIGS. 7A-7C show schematic diagrams of different forms of switching power converters as the first power conversion circuit in a conversion control circuit capable of recycling energy according to one embodiment of the present invention.

FIGS. 8A-8C show schematic diagrams of different forms of switching power converters as the second power conversion circuit in a conversion control circuit capable of recycling energy according to one embodiment of the present invention.

FIG. 9A shows a circuit diagram of a transconductance amplifier as the controllable current source circuit in a conversion control circuit capable of recycling energy according to one embodiment of the present invention.

FIG. 9B shows a circuit diagram of a transconductance amplifier as the controllable current source circuit in a conversion control circuit capable of recycling energy according to another embodiment of the present invention.

FIG. 10 shows a circuit block diagram of a flyback power converter as the isolated power converter in a conversion control circuit capable of recycling energy according to another embodiment of the present invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

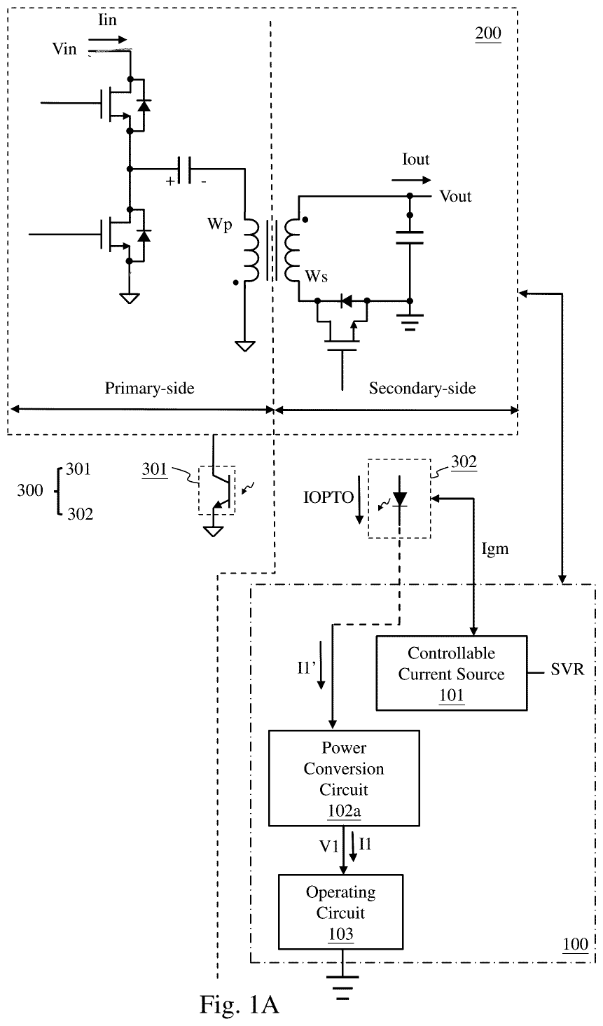

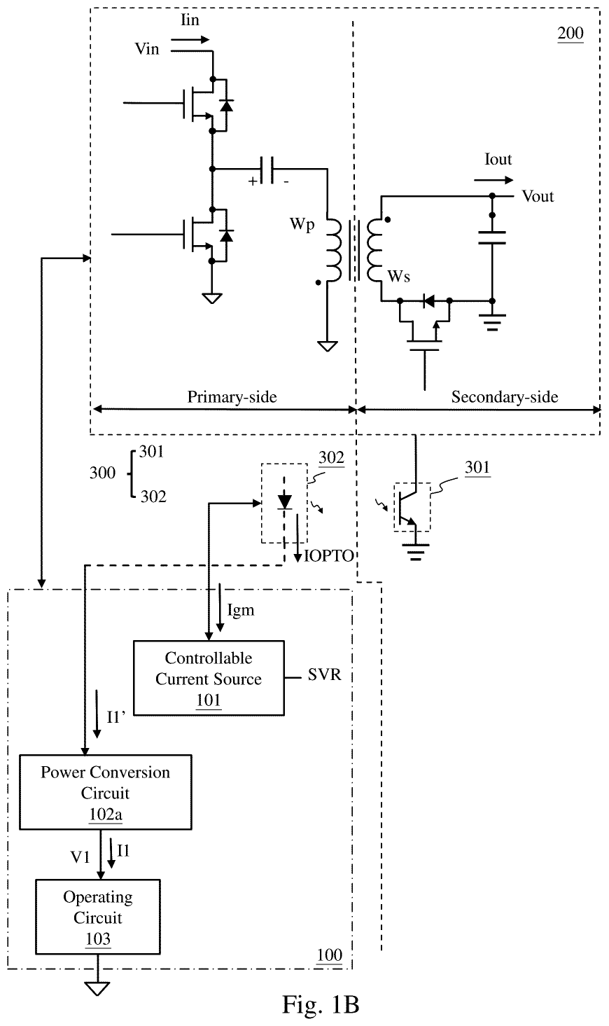

FIG. 1A shows a circuit block diagram of a conversion control circuit capable of recycling energy according to one embodiment of the present invention. FIG. 1B shows a circuit block diagram of a conversion control circuit capable of recycling energy according to another embodiment of the present invention. The conversion control circuit capable of recycling energy 100 is configured to control an isolated power converter 200 (symbolled as Iso. Power Converter) which converts an input power to generate an output power. The input power includes an input voltage Vin and an input current Iin, while the output power includes an output voltage Vout and an output current Iout. The isolated power converter 200 has a primary side coupled to the input power and a secondary side coupled to the output power. In one embodiment, the isolated power converter 200 is configured, for example, as a half-bridge resonant flyback converter (as shown in FIG. 1A).

The conversion control circuit 100 generates an optocoupler current IOPTO for a photodiode 302 included in an optocoupler 300 based on a control-related signal SVR, thereby transmitting the information related to the control-related signal SVR between the primary side and the secondary side via optical coupling to achieve the power conversion. In one embodiment, as shown in FIG. 1A, the conversion control circuit 100 can be located on the secondary side, with the information related to the control-related signal SVR transmitted from the secondary side to the primary side. In another embodiment, as shown in FIG. 1B, the conversion control circuit 100 can be located on the primary side, with the information related to the control-related signal SVR transmitted from the primary side to the secondary side.

Please refer to FIGS. 1A and 1B. The conversion control circuit 100 comprises a controllable current source circuit 101, and a first power conversion circuit 102a. The controllable current source circuit 101 generates a controllable current Igm based on the control-related signal SVR, wherein at least a portion of the controllable current Igm is coupled to provide the optocoupler current IOPTO. The first power conversion circuit 102a converts at least a portion of the optocoupler current IOPTO into a supply power (corresponding to supply voltage V1 and supply current I1) to supply an operating circuit 103, thereby recycling the energy generated by the optocoupler current IOPTO related to the output power. Specific details of the embodiment will be described later. It should be noted that the following embodiments will mainly be described with reference to the embodiment corresponding to FIG. 1A, and the detailed embodiment corresponding to FIG. 1B can be deduced by those in the art.

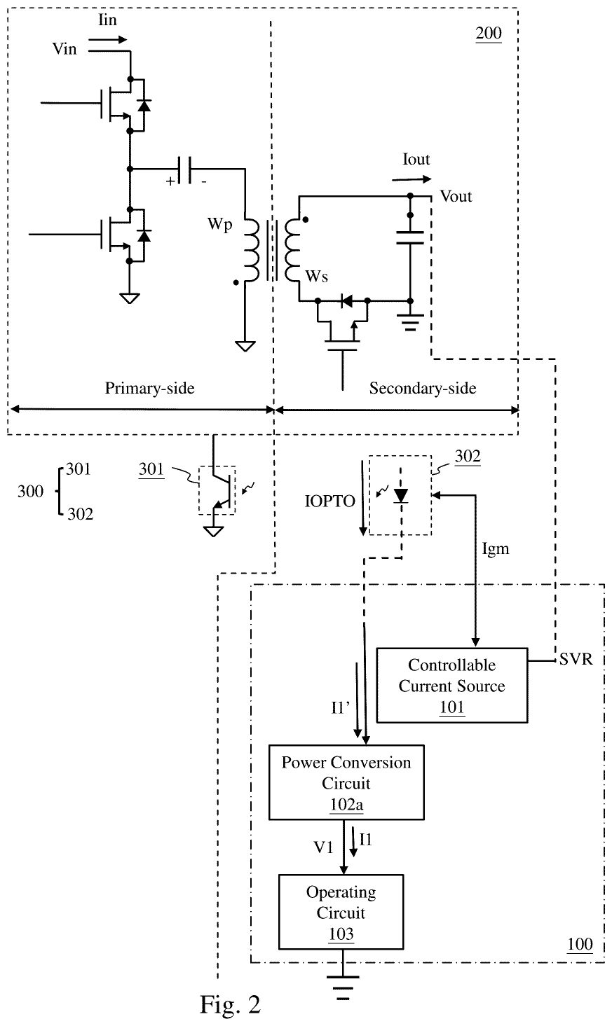

FIG. 2 shows a circuit block diagram of a conversion control circuit capable of recycling energy according to one embodiment of the present invention, wherein the control-related signal SVR is related to the electrical characteristics of the output power, such as the output voltage Vout or the output current Iout.

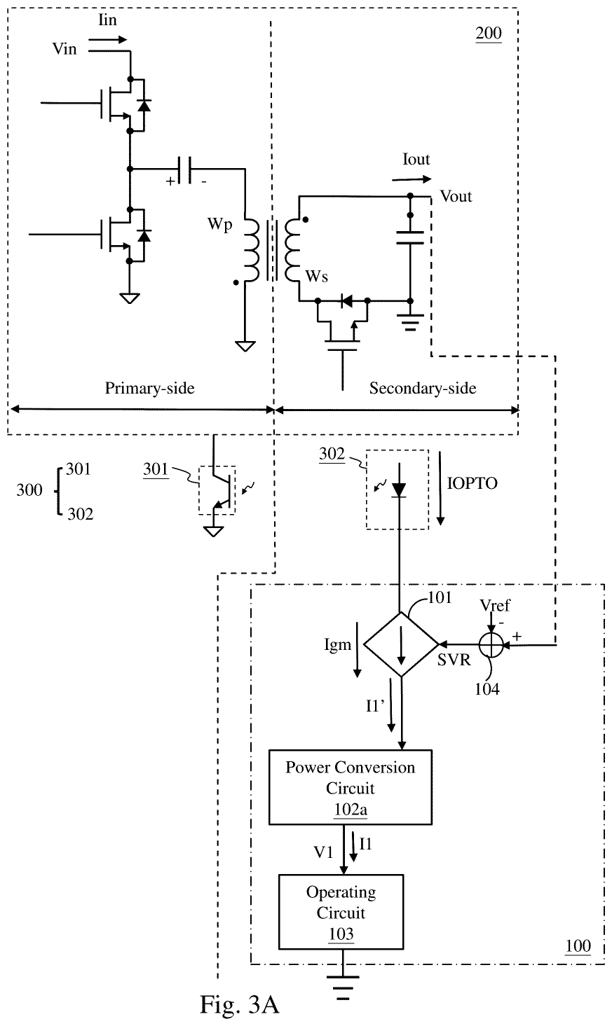

FIG. 3A shows a circuit block diagram of a conversion control circuit capable of recycling energy according to one embodiment of the present invention. This embodiment is a more specific embodiment corresponding to FIG. 2, wherein the control-related signal SVR is related to a difference between the electrical characteristics of the output power and a reference signal Vref. In one embodiment, the conversion control circuit 100 regulates the electrical characteristics to a predetermined target level based on the control-related signal SVR. Specifically, the control-related signal SVR, related to the difference between the electrical characteristics of the output power and the reference signal Vref, controls the optocoupler 300 through the optocoupler current IOPTO, thereby controlling the primary side switch of the isolated power converter 200, and regulating the output voltage Vout or output current Iout to a predetermined target level.

Continuing to refer to FIG. 3A, in one embodiment, the controllable current source circuit 101, the first power converter 102a, and the photodiode 302 are coupled in series. In other words, in one embodiment, the controllable current Igm, the optocoupler current IOPTO, and the current I1′ are approximately equal.

FIG. 3B shows a circuit block diagram of a conversion control circuit capable of recycling energy according to another embodiment of the present invention. This embodiment is similar to FIG. 3A, with the difference being that in the conversion control circuit 100′, the controllable current source circuit 101 and the first power converter 102a are coupled in parallel to the photodiode 302. In other words, in this embodiment, the optocoupler current IOPTO is equal to the sum of the controllable current Igm and the current I1′.

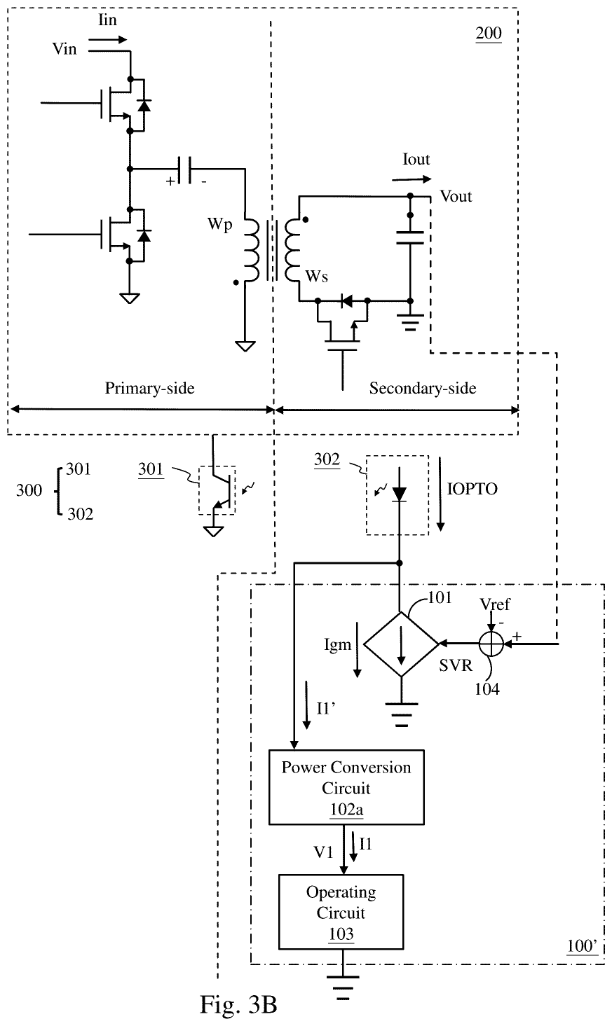

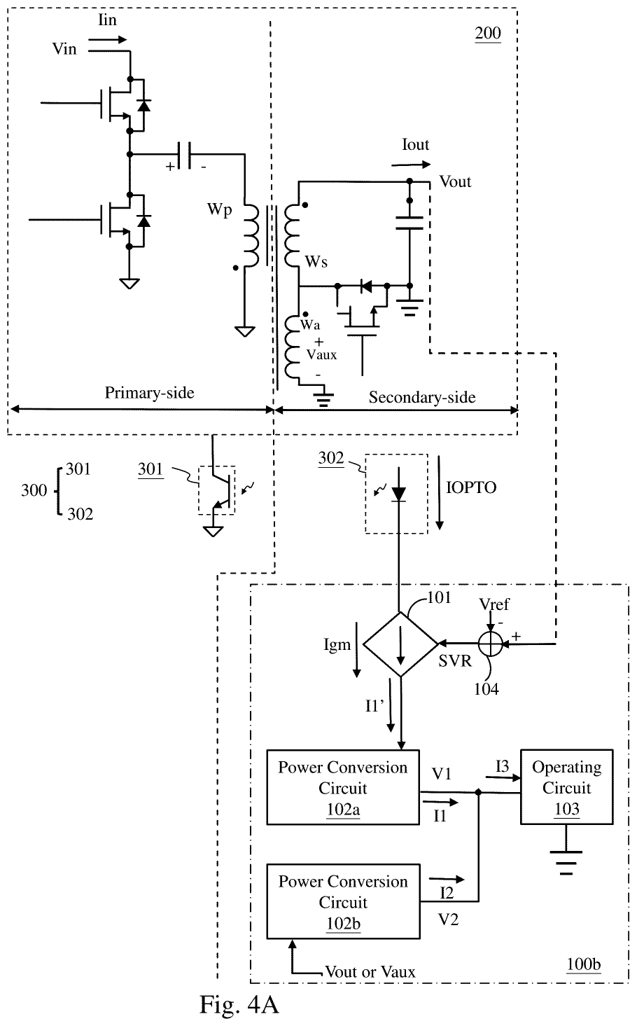

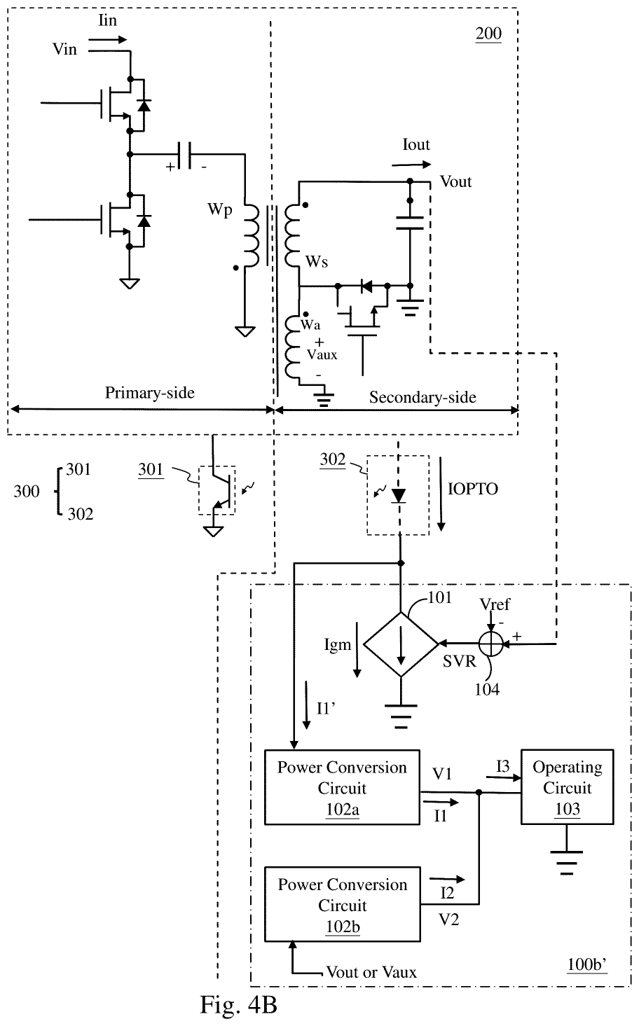

FIG. 4A shows a circuit block diagram of a conversion control circuit capable of recycling energy according to one embodiment of the present invention. FIG. 4B shows a circuit block diagram of a conversion control circuit capable of recycling energy according to another embodiment of the present invention. The embodiments of FIG. 4A and FIG. 4B are similar to those of FIG. 3A and FIG. 3B, respectively, with the difference being that the conversion control circuits 100b and 100b′ further include a second power conversion circuit 102b, which provides a regulated power, wherein the regulated power is coupled in parallel to the supply power to supply the operating circuit 103. In one embodiment, the operating circuit 103 consumes an operating current I3. As shown in FIG. 4A and FIG. 4B, in this embodiment, the regulated current I2 is related to the difference between the supply current I1 and the operating current I3. In other words, from one perspective, the regulated current I2 of the regulated power is related to the difference between at least a portion of the optocoupler current IOPTO (i.e., I1′) and the operating current I3. In one embodiment, the regulated current I2 is bidirectional, meaning that the regulated current I2, as shown, can flow out of or into the second power conversion circuit 102b.

Continuing to refer to FIG. 4A and FIG. 4B, in one embodiment, the second power conversion circuit 102b can convert the output voltage Vout or the auxiliary winding voltage Vaux (auxiliary voltage) of the power transformer 230 to generate the regulated current I2.

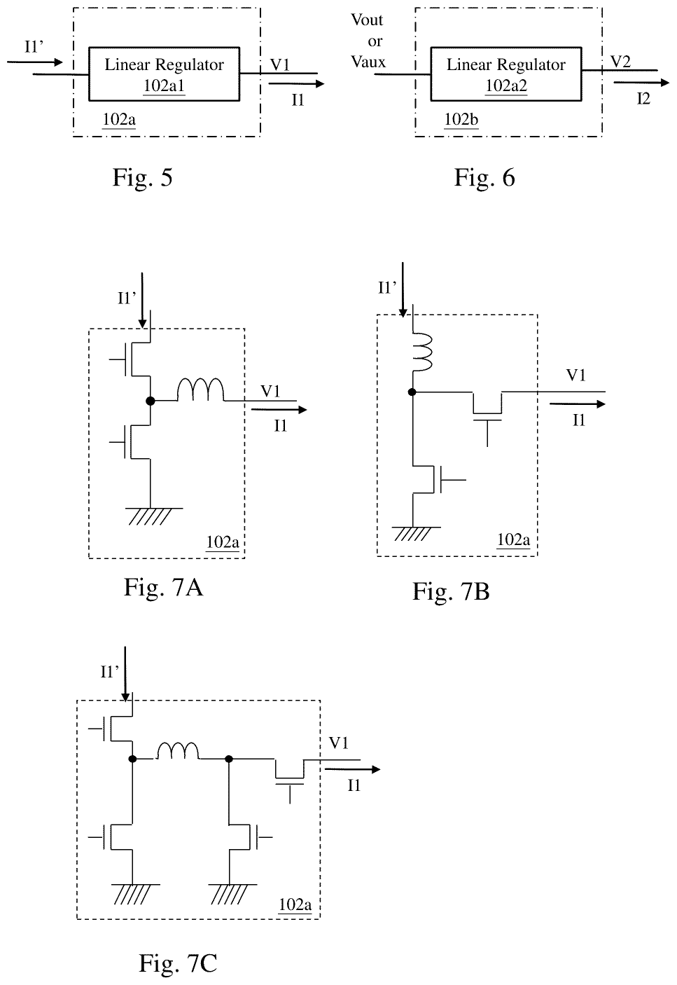

FIG. 5 shows a block diagram of the first power conversion circuit 102a in a conversion control circuit capable of recycling energy according to one embodiment of the present invention. As shown in FIG. 5, in one embodiment, the first power conversion circuit 102a can be configured as a linear regulator 102a1, which converts the current I1′ into the supply power (V1, I1) through linear control.

FIG. 6 shows a block diagram of the second power conversion circuit 102b in a conversion control circuit capable of recycling energy according to one embodiment of the present invention. As shown in FIG. 6, in one embodiment, the second power conversion circuit 102b can be configured as a linear regulator 102a1, which converts the output voltage Vout or auxiliary voltage Vaux into the regulated power (V2, I2) through linear control.

In one embodiment, the first power conversion circuit 102a can also be configured as a switching power converter. FIGS. 7A to 7C show schematic diagrams of the first power conversion circuit 102a in a conversion control circuit capable of recycling energy according to one embodiment of the present invention. As shown in FIGS. 7A to 7C, the first power conversion circuit 102a can be configured as a buck-type, boost-type, or buck-boost-type switching power converter, which converts the current I1′ into the supply power (V1, I1) through switching control.

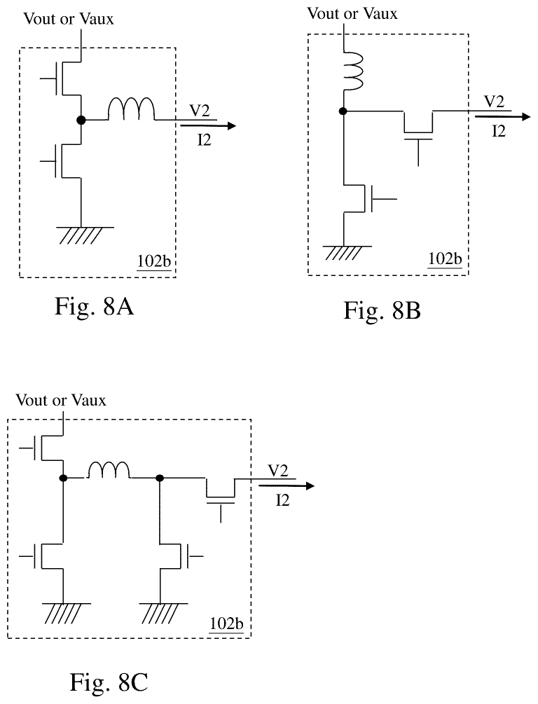

FIGS. 8A to 8C show schematic diagrams of the second power conversion circuit 102b in a conversion control circuit capable of recycling energy according to one embodiment of the present invention. As shown in FIGS. 8A to 8C, the second power conversion circuit 102b is configured as a buck-type, boost-type, or buck-boost-type switching power converter, which converts the output voltage Vout or auxiliary voltage Vaux into the regulated power (V2, I2) through switching control.

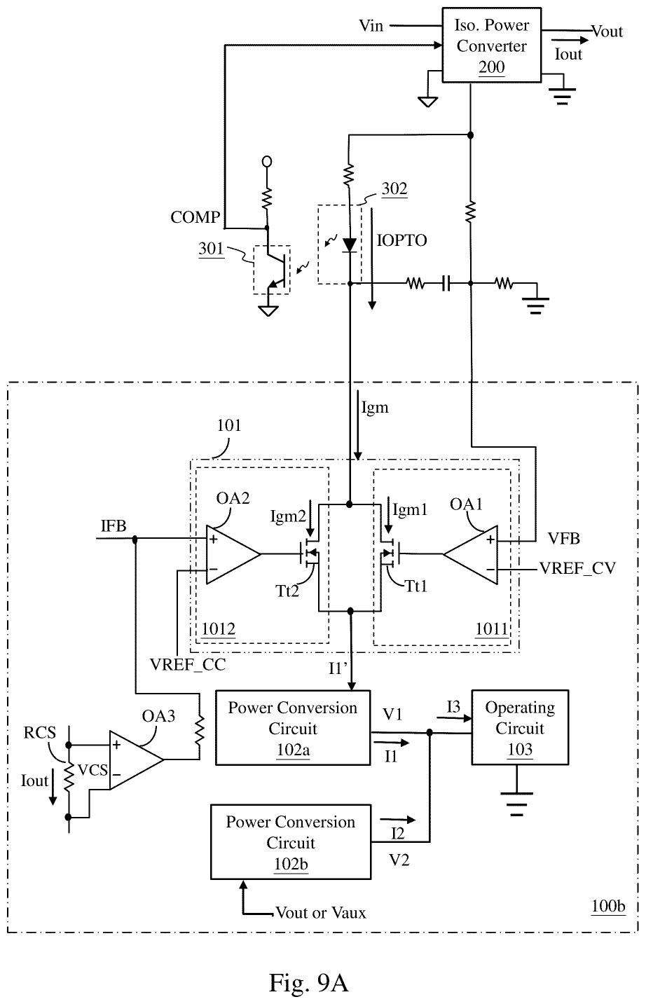

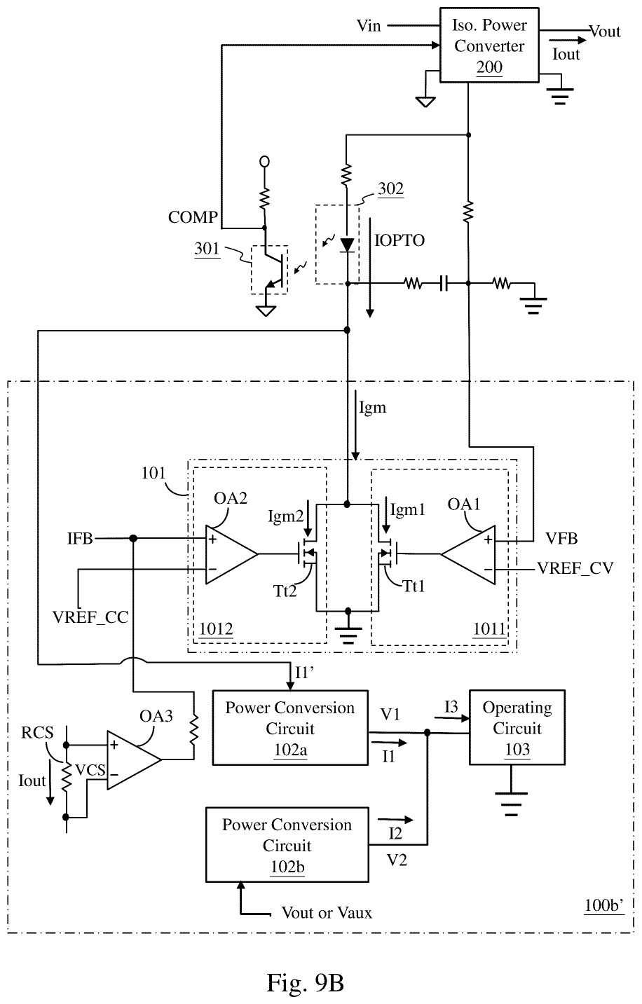

FIG. 9A shows a circuit diagram of the controllable current source circuit including a transconductance amplifier in a conversion control circuit capable of recycling energy according to one embodiment of the present invention. This embodiment corresponds to the embodiment of FIG. 4A, wherein the controllable current source circuit 101, the first power converter 102a, and the photodiode 302 are coupled in series. In this embodiment, the controllable current source circuit 101 includes transconductance amplifiers 1011 and/or 1012, which generate the controllable current Igm based on the difference between the feedback voltage signal VFB related to the output voltage Vout and the voltage reference signal VREF_CV, and/or the difference between the feedback current signal IFB related to the output current Iout and the current reference signal VREF CC. The feedback voltage signal VFB is, for example, a divided voltage of the output voltage Vout, and the feedback current signal IFB is, for example, a sensing signal proportional to the output current Iout.

Continuing to refer to FIG. 9A, specifically, this embodiment includes two feedback loops. One is a constant voltage control loop that generates the controllable current Igm based on the difference between the feedback voltage signal VFB and the voltage reference signal VREF_CV, thereby controlling the isolated power converter to perform power conversion and regulate the output voltage Vout to a predetermined level. The other feedback loop is a constant current control loop that generates the controllable current Igm based on the difference between the feedback current signal IFB and the current reference signal VREF_CC, thereby regulating the output current Iout to a predetermined level.

FIG. 9B shows a circuit diagram of the controllable current source circuit including a transconductance amplifier in a conversion control circuit capable of recycling energy according to another embodiment of the present invention. FIG. 9B is similar to FIG. 9A, with the difference being that FIG. 9B corresponds to the embodiment of FIG. 4B, wherein the controllable current source circuit 101 and the first power converter 102a are coupled in parallel to the photodiode 302.

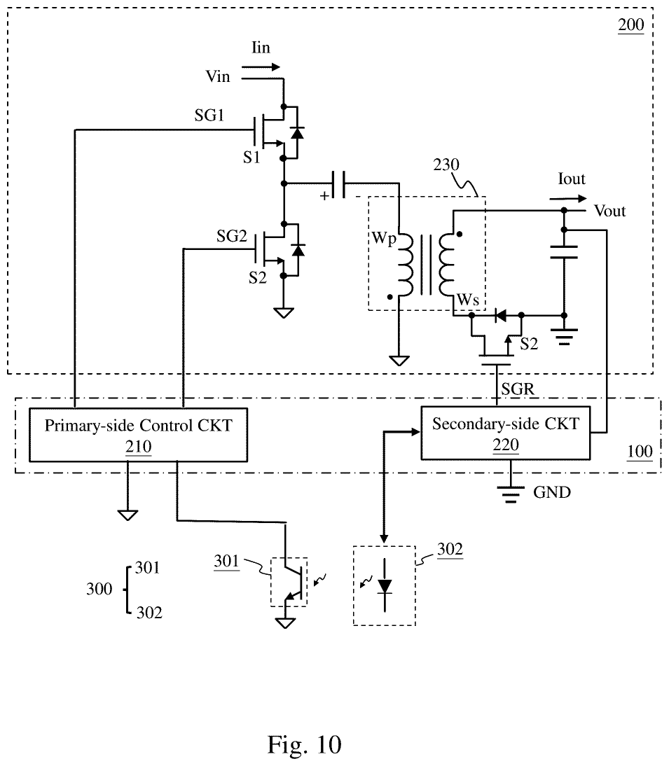

FIG. 10 shows a schematic diagram of the isolated power converter 200 as a flyback power converter in a conversion control circuit capable of recycling energy according to another embodiment of the present invention. The isolated power converter 200 is a flyback power converter, which includes a power transformer 230 coupled between the input power and the output power; a half-bridge circuit comprising a primary-side upper bridge switch S1 and a primary-side lower bridge switch S2, configured to switch a primary winding Wp of the power transformer 230 and a resonant capacitor Cr forming a resonant circuit; and a synchronous rectifying (SR) switch SSR, coupled in series with a secondary winding Ws of the power transformer 230 between the output power and a secondary-side ground node GND. The conversion control circuit 100 includes a primary-side control circuit 210 (symbolled as Primary-side Control CKT), coupled to a phototransistor 301 included in the optocoupler 300, to generate switching signals SG1 and SG2 to control the primary-side upper bridge switch S1 and the primary-side lower bridge switch S2, switching the primary winding Wp of the power transformer 230. The conversion control circuit 100 also includes a secondary-side control circuit 220 (symbolled as Secondary-side Control CKT), coupled to the photodiode 302, to generate a synchronous rectification control signal SGR, controlling the synchronous rectifying switch SSR, switching the secondary winding Ws of the power transformer 230 to generate the output voltage Vout. In this embodiment, the secondary-side control circuit generates the optocoupler current IOPTO to drive the photodiode 302.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A conversion control circuit capable of recycling energy for controlling an isolated power converter, wherein the isolated power converter is configured to convert an input power to generate an output power, the isolated power converter having a primary side coupled to the input power and a secondary side coupled to the output power, wherein the conversion control circuit generates an optocoupler current for a photodiode included in the optocoupler based on a control-related signal, thereby transmitting information related to the control-related signal between the primary side and the secondary side via optical coupling to achieve power conversion, the conversion control circuit comprising:
a controllable current source circuit configured to generate a controllable current based on the control-related signal, wherein at least a portion of the controllable current provides the optocoupler current; and
a first power conversion circuit configured to convert at least a portion of the optocoupler current into a supply power for an operating circuit, thereby recycling the energy generated by the optocoupler current.

2. The conversion control circuit capable of recycling energy according to claim 1, further comprising:
a second power conversion circuit, configured to provide a regulated power, wherein the regulated power and the supply power are connected in parallel to power the operating circuit.

3. The conversion control circuit capable of recycling energy according to claim 2, wherein the operating circuit consumes an operating current for operation;
wherein a regulation current of the regulated power is related to a difference between the at least a portion of the optocoupler current and the operating current; or
the regulation current is related to a difference between a supply current of the supply power and the operating current.

4. The conversion control circuit capable of recycling energy according to claim 1, wherein the first power conversion circuit is a linear regulator or a switching power converter.

5. The conversion control circuit capable of recycling energy according to claim 2, wherein the second power conversion circuit is a linear regulator or a switching power converter.

6. The conversion control circuit capable of recycling energy according to claim 1, wherein the control-related signal is related to an electrical characteristic of the output power, and the conversion control circuit regulates the electrical characteristic to a predetermined target level based on the control-related signal.

7. The conversion control circuit capable of recycling energy according to claim 6, wherein the controllable current source circuit includes a transconductance amplifier to convert the difference between the electrical characteristic and a reference signal into the controllable current.

8. The conversion control circuit capable of recycling energy according to claim 7, wherein the electrical characteristic is an output voltage or an output current of the output power.

9. The conversion control circuit capable of recycling energy according to claim 1, wherein the controllable current source circuit and the first power conversion circuit are coupled in parallel and then are coupled to the photodiode; or the controllable current source circuit, the first power conversion circuit, and the photodiode are coupled in series.

10. The conversion control circuit capable of recycling energy according to claim 2, wherein the regulation current is bidirectional.

11. The conversion control circuit capable of recycling energy according to claim 1, wherein the isolated power converter is a flyback power converter, which includes:
a power transformer coupled between the input power and the output power;
a half-bridge circuit which includes a primary-side high-side switch and a primary-side low-side switch to switch a resonant circuit formed by a primary winding of the power transformer and a resonant capacitor; and
a synchronous rectifying (SR) switch coupled in series with a secondary winding of the power transformer between the output power and a secondary ground node;
wherein the primary-side high-side switch and the primary-side low-side switch are controlled by a primary-side control circuit coupled to a phototransistor included in the optocoupler to generate a switching signal, which controls the primary-side high-side switch and the primary-side low-side switch to switch the primary winding of the power transformer;
wherein the SR switch is controlled by a secondary-side control circuit which generates the optocoupler current to drive the photodiode and produces an SR control signal to control the on-off state of the SR switch, thereby switching the secondary winding of the power transformer to generate the output voltage;
wherein the conversion control circuit includes the secondary-side control circuit.

12. The conversion control circuit capable of recycling energy according to claim 11, wherein the second power conversion circuit converts the output voltage or a cross-voltage of an auxiliary winding included in the power transformer to generate the regulation current.

13. A conversion control method capable of recycling energy for controlling an isolated power converter that converts an input power to generate an output power, wherein the isolated power converter includes a primary side coupled to the input power and a secondary side coupled to the output power; the conversion control method comprising:
generating an optocoupler current for a photodiode included in the optocoupler based on a control-related signal, thereby transmitting information related to the control-related signal between the primary and secondary sides via optical coupling to achieve power conversion;
generating a controllable current based on the control-related signal, wherein at least a portion of the controllable current provides the optocoupler current; and
converting at least a portion of the optocoupler current into a supply power to power an operating circuit, thereby recycling the energy generated by the optocoupler current.

14. The conversion control method capable of recycling energy according to claim 13, further comprising:
providing a regulated power, wherein the regulated power and the supply power are connected in parallel to power the operating circuit.

15. The conversion control method capable of recycling energy according to claim 14, wherein the operating circuit consumes an operating current for operation;
wherein a regulation current of the regulated power is related to a difference between the at least a portion of the optocoupler current and the operating current; or
the regulation current is related to a difference between a supply current of the supply power and the operating current.

16. The conversion control method capable of recycling energy according to claim 13, wherein the control-related signal is related to an electrical characteristic of the output power, and the electrical characteristic is regulated to a predetermined target level based on the control-related signal.

17. The conversion control method capable of recycling energy according to claim 16, further comprising:
converting the difference between the electrical characteristic and the reference signal into the controllable current.

18. The conversion control method capable of recycling energy according to claim 17, wherein the electrical characteristic is an output voltage or an output current of the output power.

19. The conversion control method capable of recycling energy according to claim 15, wherein the regulation current is bidirectional.

20. The conversion control method capable of recycling energy according to claim 19, further comprising:
converting the output voltage or a cross-voltage of an auxiliary winding to generate the regulation current.
